(19) United States
(12) Patent Application Publication
(10) Pub. No.: US 2026/0180303 A1
(43) Pub. Date: Jun. 25, 2026

(54) BUS BAR UNIT AND BRUSHLESS MOTOR

(71) Applicant: MABUCHI MOTOR CO., LTD., Chiba (JP)

(72) Inventor: Kazuya INOZUME, Chiba (JP)

(21) Appl. No.: 19/147,713

(22) PCT Filed: Dec. 23, 2024
(86) PCT No.: PCT/JP2024/045419

§ 371 Date: Jul. 14, 2025

(51) Int. Cl. H02G 5/06; H02K 1/16; H02K 1/274; H02K 3/12; H02K 7/00; H02K 11/00

(52) U.S. Cl. CPC H02G 5/061; H02K 1/165; H02K 1/274; H02K 3/12; H02K 7/003; H02K 11/0094

(57) ABSTRACT

A holder, which covers bus bars, of a bus bar unit includes a ring-shaped region. The bus bars are placed in the ring-shaped region, centers of the arcs are displaced from one another, and a part of each bus bar overlaps another bus bar in a predetermined angle area in the ring-shaped region. Alternatively, a bus bar unit of an inner rotor brushless motor includes a holder configured to be mounted on a stator, and bus bars configured to connect coils of three phases of the stator on a phase by phase basis. Each bus bar extends along a circumferential direction and is covered with the holder at the same position in an axial direction. A first portion of each bus bar is located radially inward of a second portion of the bus bar, and overlaps the second portion of another bus bar as viewed in the radial direction.

### TECHNICAL FIELD

The present invention relates to a bus bar unit and a brushless motor including the bus bar unit.

### BACKGROUND ART

A brushless motor is conventionally known in which windings of a plurality of coils provided to a stator are connected using a conductive bus bar. For example, Patent Literature 1 discloses a brushless motor including a connection bus bar (bus bar unit) having a plurality of conductive plates (referred to here as bus bars) that connects windings of a plurality of coils and an insulating member that accommodates the conductive plates stacked in an axial direction.

### CITATION LIST

### Patent Literature

Patent Literature 1: Japanese Patent No. 7280070

### DISCLOSURE OF THE INVENTION

### Problems to be Solved by the Invention

Incidentally, a configuration in which a plurality of bus bars is stacked in an axial direction as in the brushless motor of Patent Literature 1 is required to secure a space for placing the stacked bus bars inside the motor, and there is room for improvement if it is not desired to increase the size of the motor in the axial direction. Note that the above problem is a problem that may arise when a plurality of bus bars is provided to a bus bar unit, and is not limited to a case where a component that is connected by the bus bar is a coil of a motor, and is not limited to a case where a device provided with the bus bar unit is a motor.

The present invention has been devised in view of such a problem, and one of objects thereof is to provide a bus bar unit that can prevent an increase in the size of a device provided with the bus bar unit, and a brushless motor including the bus bar unit. Note that objects of the present invention are not limited to this object, but also include another object of exerting operations and effects that can be derived from configurations presented in DESCRIPTION OF PREFERRED EMBODIMENTS described below, the operations and effects being unobtainable by the known technology.

### Solutions to the Problems

A bus bar unit and brushless motor of the disclosure can be achieved as aspects (application examples) disclosed below, and solves at least a part of the above problem.

Aspect 1. A bus bar unit of the disclosure includes: a plurality of arc-shaped bus bars; and a holder having a ring shape around an axis, the holder being configured to cover the plurality of bus bars. The holder includes a ring-shaped region having a predetermined radial width about the axis on a plane orthogonal to the axis, the bus bars are placed in the ring-shaped region, and centers of the arcs are displaced from one another, and at least a part of each of the bus bars overlaps with another bus bar in a predetermined angle area in the ring-shaped region.

Aspect 2. Another bus bar unit of the disclosure is a bus bar unit of an inner rotor brushless motor including a ring-shaped stator and a rotor located on a radially inner side of the stator, the bus bar unit including: a resin holder configured to be mounted on a predetermined axial direction side of the stator in an axial direction of the stator; and a plurality of conductive bus bars configured to connect coils of three phases provided to the stator on a phase by phase basis. Each of the bus bars extends along a circumferential direction of the stator and is covered with the holder at the same position in the axial direction relative to the holder, and a first portion on one end side in the circumferential direction is located on the inner side relative to a second portion on the other end side in the circumferential direction, and the first portion of each of the bus bars and the second portion of any of the bus bars other than the bus bar overlap each other as viewed in the radial direction.

Aspect 3. A brushless motor of the disclosure includes: the bus bar unit including Aspect 2 above; the stator on which the bus bar unit is mounted; and the rotor configured to rotate integrally with a shaft on the inner side of the stator.

### Effects of the Invention

According to the invention of the disclosure, it is possible to provide a bus bar unit that can prevent an increase in the size of a device provided with the bus bar unit, and it is also possible to provide a brushless motor including the bus bar unit.

### BRIEF DESCRIPTION OF THE DRAWINGS

FIG. 1 is an exploded perspective view of a brushless motor to which a bus bar unit according to an embodiment is applied.

FIG. 2 is a perspective view of a stator included in the brushless motor of FIG. 1.

FIG. 3 is a diagram schematically illustrating a wiring method and a connection method of windings forming coils provided to the stator of FIG. 2.

FIG. 4 is a diagram for explaining characteristics of a start wire and end wire of a winding, and is a perspective view illustrating a part of a core unit of the stator and a winding wound around the part.

FIG. 5 is a perspective view of a first bus bar unit and the stator, which are included in the brushless motor of FIG. 1, as viewed in a first axial direction.

FIG. 6 is a cross-sectional view on arrows X-X of the first bus bar unit of FIG. 5.

FIG. 7 is an axial sectional view of the first bus bar unit of FIG. 6, taken along a plane P.

FIG. 8 is a perspective view of the first bus bar unit of FIG. 5 as viewed in a second axial direction.

FIG. 9 is a perspective view of a second bus bar unit and the stator, which are included in the brushless motor of FIG. 1, as viewed in the second axial direction.

### DESCRIPTION OF PREFERRED EMBODIMENTS

A bus bar unit and a brushless motor as embodiments are described with reference to the drawings. The embodiments presented below are mere exemplifications, and there is no intention to preclude various modifications and application of a technology, which are not explicitly stated in the embodiments below. The configurations of the embodiments can be modified and carried out in various manners within the scope that does not depart from the purport of the configurations.

A bus bar unit includes: a plurality of arc-shaped bus bars; and a holder having a ring shape around an axis, the holder being configured to cover the plurality of bus bars. The holder includes a ring-shaped region having a predetermined radial width about the axis on a plane orthogonal to the axis. The bus bars are placed in the ring-shaped region of the holder, and centers of the arcs are displaced from one another, and at least a part of each of the bus bars overlaps with another bus bar in a predetermined angle area in the ring-shaped region. Such a configuration enables the plurality of bus bars to be placed without overlapping one another in a direction of the axis (an axial direction); therefore, it is encouraged to prevent an increase in the size (particularly, the size in the axial direction) of a device provided with the bus bar unit. The bus bar unit described in detail below is applied to a brushless motor as an example, but an application target of the above bus bar unit is not limited to a motor, and may be various electrical components such as a switchboard, a storage battery, and a generator.

Alternatively, the bus bar unit may be applied to an inner rotor brushless motor. The bus bar unit in this case includes: a resin holder configured to be mounted on a predetermined axial direction side of a stator of the brushless motor; and a plurality of conductive bus bars configured to connect coils of three phases provided to the stator on a phase by phase basis. Each of the bus bars extends along a circumferential direction and is covered with the holder at the same position in an axial direction relative to the holder, and a first portion on one end side in the circumferential direction is located on a radially inner side relative to a second portion on the other end side in the circumferential direction. Moreover, the first portion of each of the bus bars and the second portion of any of the bus bars other than the bus bar overlap each other as viewed in the radial direction. Such a configuration also enables the plurality of bus bars to be placed without overlapping one another in the axial direction; therefore, it is encouraged to prevent an increase in the size (particularly, the size in the axial direction) of the brushless motor provided with the bus bar unit. In addition, the first portion and the second portion of each of the bus bars can be extended to near the coils connected by the bus bar; therefore, the routing of windings of the coils connected by the bus bar is prevented from becoming complicated.

### 1. Configuration

### 1-1. Overall Configuration

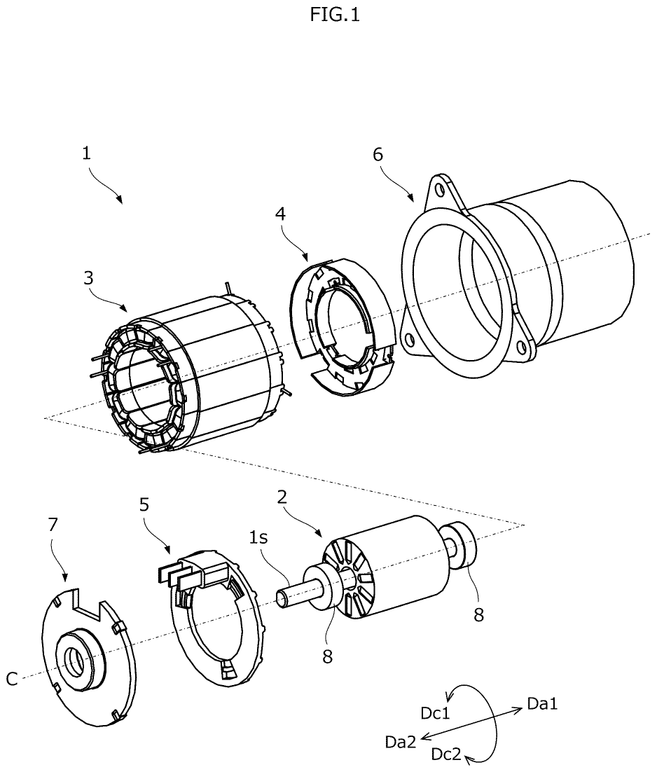

FIG. 1 is an exploded perspective view of a brushless motor 1 (hereinafter also referred to as the “motor 1”) to which a bus bar unit according to the embodiment is applied. The brushless motor 1 according to the embodiment is an inner rotor brushless motor, and includes a rotor 2 that rotates integrally with a shaft 1s, a stator 3, and bus bar units 4 and 5 as illustrated in FIG. 1. The motor 1 is configured by integrating the rotor 2, the stator 3, and the bus bar units 4 and 5 into a bottomed cylindrical housing 6. An end bell 7 as a lid member may be assembled to an opening side (the left side in the drawing) of the housing 6.

Hereinafter, an extension direction of the shaft 1s (a direction of an axis C of the shaft 1s) is referred to as the axial direction. In the axial direction, a direction in which the bottom portion of the housing 6 is located relative to the opening of the housing 6 (the right side in FIG. 1) is referred to as a first axial direction Da1 (a predetermined axial direction), and a direction opposite to the first axial direction Da1 is referred to as a second axial direction Da2. A direction orthogonal to the axial direction, the direction being away from the axis C and toward the axis C, is referred to as the radial direction. In the radial direction, a direction away from the axis C is referred to as the radially outer side (radially outward), and a direction toward the axis C is referred to as the radially inner side (radially inward). A direction orthogonal to the axial direction, the direction circling around the axis C, is referred to as the circumferential direction. In the circumferential direction, as viewed in the first axial direction Da1, a clockwise direction is referred to as a first circumferential direction Dc1, and a direction opposite to the first circumferential direction Dc1 (a counterclockwise direction) is referred to as a second circumferential direction Dc2.

As illustrated in FIG. 1, the motor 1 exemplified here includes two bus bar units 4 and 5 that are provided in such a manner as to sandwich the stator 3 in the axial direction. Hereinafter, the bus bar unit 4 located on the first axial direction Da1 side of the stator 3 is referred to as the first bus bar unit 4, and the bus bar unit 5 located on the second axial direction Da2 side of the stator 3 is referred to as the second bus bar unit 5. The first bus bar unit 4, the stator 3, and the second bus bar unit 5 are placed in this order from the first axial direction Da1 toward the second axial direction Da2, and are integrated into the housing 6. The rotor 2 and the shaft 1s are inserted through the stator 3 and the two bus bar units 4 and 5 on the radially inner side. The bus bar unit according to the embodiment is provided (applied) as the first bus bar unit 4.

### 1-2. Rotor

The rotor 2 includes, for example, a rotor core that rotates integrally with the shaft 1s, and a plurality of magnets embedded in the rotor core. The shaft 1s is a rotary shaft that supports the rotor 2, and also functions as an output shaft that extracts output (mechanical energy) of the motor 1 to the outside. The shaft 1s is rotatably supported by the bottom portion of the housing 6 and the end bell 7 via, for example, bearings 8 in two places sandwiching the rotor core in the axial direction.

### 1-3. Stator

The stator 3 is a ring-shaped component having, on the radially inner side, a space in which the rotor 2 is placed, and is placed concentrically with the axis C. Therefore, the above-mentioned axial direction, radial direction, and circumferential direction of the axis C also translate into the axial direction, radial direction, and circumferential direction of the stator 3 respectively. An external shape of the stator 3 of the embodiment is a circular ring (cylindrical) shape, but the shape of the stator 3 is not limited thereto.

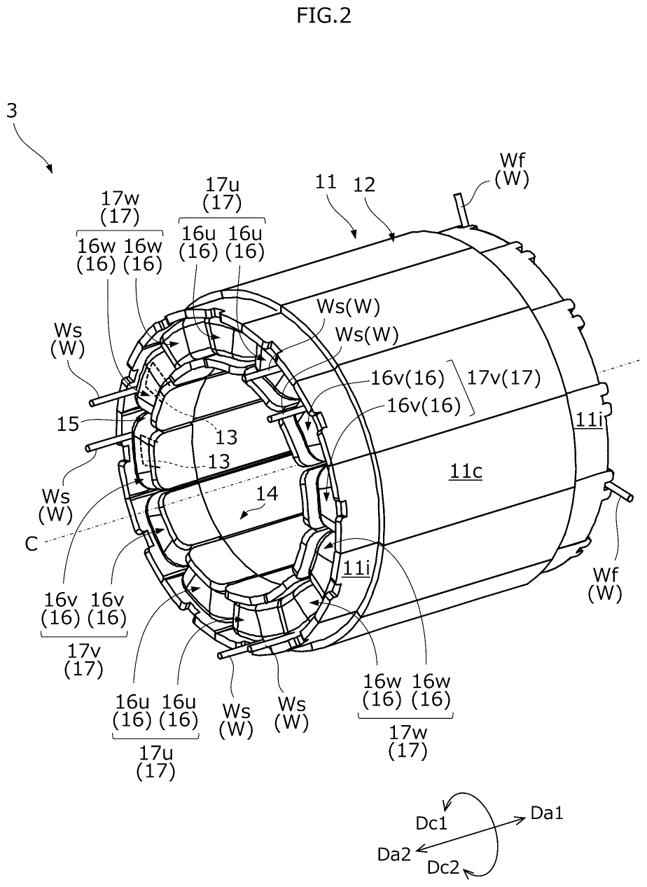

As illustrated in FIG. 2, the stator 3 includes an approximately cylindrical core unit 11 and a plurality of coils 16. The core unit 11 is provided as, for example, an insert-molded product obtained by molding a stator core 11c in which a plurality of steel sheets having the same shape is stacked with resin to be insulators 11i, and is fixed in the housing 6.

The core unit 11 includes a cylindrical outer peripheral wall 12, a plurality of teeth 13 protruding radially inward from an inner peripheral surface of the outer peripheral wall 12, and circular arc-shaped inner peripheral walls 14 extending in the circumferential direction on the radially inner sides of their respective teeth 13. The plurality of teeth 13 is equally spaced apart from one another in the circumferential direction. Slots 15 as many as the teeth 13 are formed between the plurality of teeth 13. The coils 16 are formed by winding windings W around the plurality of teeth 13, and are provided as many as the teeth 13.

Note that in the core unit 11, the insulators 11i are simply required to insulate the stator core 11c from the coils 16, and may not cover the entire outer surface of the stator core 11c. For example, on the outer peripheral wall 12, the insulators 11i may not cover the outer peripheral surface of the stator core 11c. As illustrated, the outer peripheral surface of the stator core 11c may be provided in such a manner as to be located radially outward of outer peripheral surfaces of the insulators 11i provided on both sides of the outer peripheral surface of the stator core 11c in the axial direction. Put another way, steps formed by the stator core 11c and the insulators 11i may be provided on both sides of an outer peripheral surface of the outer peripheral wall 12 in the axial direction, respectively. The step can be used to mount a holder 20, which is described below, of the first bus bar unit 4 on the stator 3.

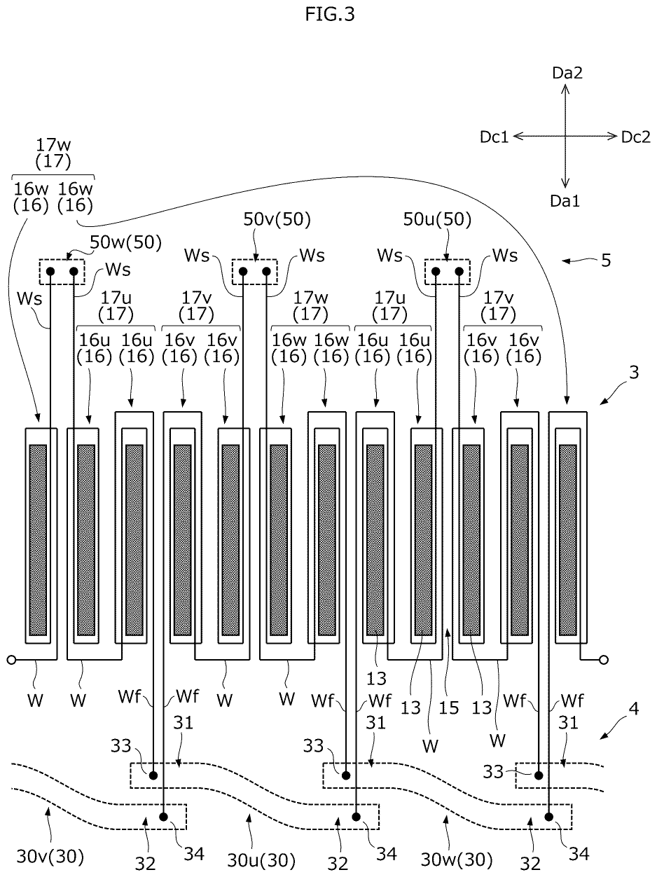

As illustrated in FIGS. 2 and 3, the stator 3 of the embodiment is provided with 12 teeth 13, 12 slots 15, and 12 coils 16. The stator 3 is provided with four phase-U coils 16u, four phase-V coils 16v, and four phase-W coils 16w as the 12 coils 16. Phase-U current is supplied to the phase-U coils 16u, phase-V current is supplied to the phase-V coils 16v, and phase-W current is supplied to the phase-W coils 16w.

Note that in FIG. 2, of the 12 teeth 13, only two teeth 13 adjacent to each other in the circumferential direction are illustrated with broken lines. Moreover, of the 12 slots 15, only one slot 15 formed between the two illustrated teeth 13 is assigned the reference sign. In FIG. 3, only parts of the 12 teeth 13 and the 12 slots 15 are assigned their respective reference signs.

In the stator 3, for example, as illustrated in FIG. 2, two pairs of the phase-U coils 16u, two pairs of the phase-V coils 16v, and two pairs of the phase-W coils 16w are provided side by side in the circumferential direction. In other words, two of the four phase-U coils 16u are provided adjacent to each other in the circumferential direction, and two phase-V coils 16v are provided adjacent to each other in the circumferential direction, adjacent to the second circumferential direction Dc2 side of the two phase-U coils 16u. Moreover, two phase-W coils 16w are provided adjacent to each other in the circumferential direction, adjacent to the second circumferential direction Dc2 side of the two phase-V coils 16v, and the remaining two of the four phase-U coils 16u are provided adjacent to each other in the circumferential direction, adjacent to the second circumferential direction Dc2 side of the two phase-W coils 16w. The remaining two phase-V coils 16v are provided adjacent to each other in the circumferential direction, adjacent to the second circumferential direction Dc2 side of the remaining two phase-U coils 16u, and the remaining two phase-W coils 16w are provided adjacent to each other in the circumferential direction, adjacent to the second circumferential direction Dc2 side of the remaining two phase-V coils 16v.

Each two in-phase coils 16 placed adjacent to each other is collectively referred to as a coil group 17. This means that the stator 3 including the 12 coils 16 includes two phase-U coil groups 17u, two phase-V coil groups 17v, and two phase-W coil groups 17w. Moreover, in terms of the above-mentioned placement of the coils 16, to put another way, the phase-U coil group 17u, the phase-V coil group 17v, and the phase-W coil group 17w are placed side by side in the circumferential direction, one by one in rotation in this order, until the stator 3 is provided with two coil groups 17 of each phase in such a manner as to face each other across the axis C.

In the embodiment, as illustrated in FIG. 3, each of the coil groups 17 is formed by one continuous winding W. In other words, the stator 3 is provided with six windings W, and each of the windings W is wound around two teeth 13 adjacent to each other in the circumferential direction to form each of the coil groups 17. More specifically, each of the windings W forming its respective coil group 17 is wound around one of the two teeth 13 adjacent to each other in the circumferential direction and then around the other of the two teeth 13 without being cut. As illustrated, each of the windings W forming its respective coil group 17 may be routed (wired) in such a manner that the winding direction of the one of the teeth 13 is opposite to the winding direction of the other of the teeth 13.

One of a start wire Ws and an end wire Wf of each of the windings W is drawn out in the first axial direction Da1, and the other is drawn out in the second axial direction Da2. In the embodiment, as illustrated in FIG. 3, the start wires Ws of the six windings W are all drawn out in the second axial direction Da2, and the end wires Wf of the six windings W are all drawn out in the first axial direction Da1. The six start wires Ws drawn out in the second axial direction Da2 are joined to bus bars 50, which are described below, of the second bus bar unit 5, and the six end wires Wf drawn out in the first axial direction Da1 are joined to bus bars 30, which are described below, of the first bus bar unit 4.

In terms of the six start wires Ws drawn out in the second axial direction Da2, the start wires Ws of the windings W forming the adjacent coil groups 17 may be drawn out from the same (common) slots 15. In the embodiment, two start wires Ws are drawn out from each of three slots 15 being every fourth slot located in the circumferential direction. Similarly, in terms of the six end wires Wf drawn out in the first axial direction Da1, the end wires Wf of the windings W forming the adjacent coil groups 17 may be drawn out from the same slots 15. In the embodiment, two end wires Wf are drawn out from each of three slots 15 being every fourth slot located in the circumferential direction. The start wire Ws and end wire Wf of each of the windings W may be drawn out from different slots 15 as illustrated in FIG. 3, or may be drawn out from the same slot 15.

Note that the start wire Ws referred to herein means a portion, at which a winding process starts, of each of the windings W (conductive wires) forming its respective coil group 17, and the end wire Wf means a portion, at which the winding process ends, of each of the windings W (the conductive wires) forming its respective coil group 17. Electricity supplied to each of the coil groups 17 may flow from the start wire Ws to the end wire Wf, or from the end wire Wf to the start wire Ws. Therefore, the start wire Ws and the end wire Wf are defined regardless of the flow direction of the electricity supplied to each of the coil groups 17.

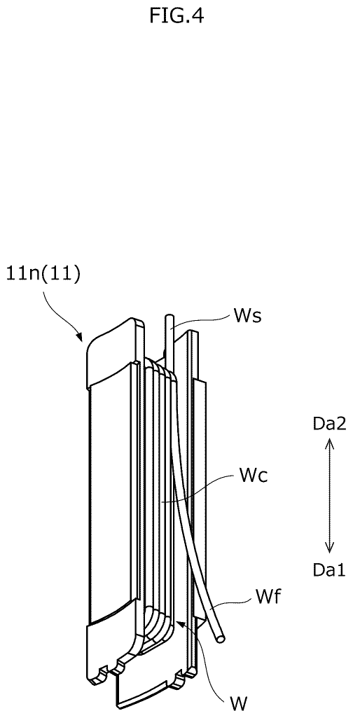

FIG. 4 is a perspective view illustrating a part of the core unit 11 as an example for explaining the characteristics of the start wire Ws and the end wire Wf of the winding W, and the winding W wound around the part. FIG. 4 illustrates only one of 12 split cores 11n obtained by dividing the core unit 11 into 12 pieces in the circumferential direction, as the part of the core unit 11. The core unit 11 may be configured by combining the split cores 11n divided equally in the circumferential direction in this manner.

Moreover, a description has been given, assuming that one coil group 17 including two in-phase coils 16 is formed by continuously winding one winding W around two adjacent teeth 13 in the stator 3 of the embodiment as described above. However, FIG. 4 illustrates a case where one winding W is wound around only one split core 11n (one tooth) to form one coil 16. In this manner, the stator 3 may be provided with as many windings W as the teeth 13.

As illustrated in FIG. 4, a connecting wire Wc that connects the start wire Ws and the end wire Wf is wound around the tooth; therefore, the start wire Ws of the winding W is restrained and fixed by the connecting wire Wc. The start wire Ws of each of the windings W forming its respective coil group 17 is fixed in this manner and therefore has a characteristic that the positions of the start wires Ws in the radial direction are less likely to vary (with little play) among the coil groups 17. On the other hand, the end wire Wf, which is a winding end portion of the winding W, is not restrained by the connecting wire Wc and therefore has a characteristic of being freely drawn radially inward or outward and in the first axial direction Da1. From these characteristics, to put another way, the start wire Ws is a fixed end of the winding W, and the end wire Wf is a fee end of the winding W.

### 1-4. First Bus Bar Unit

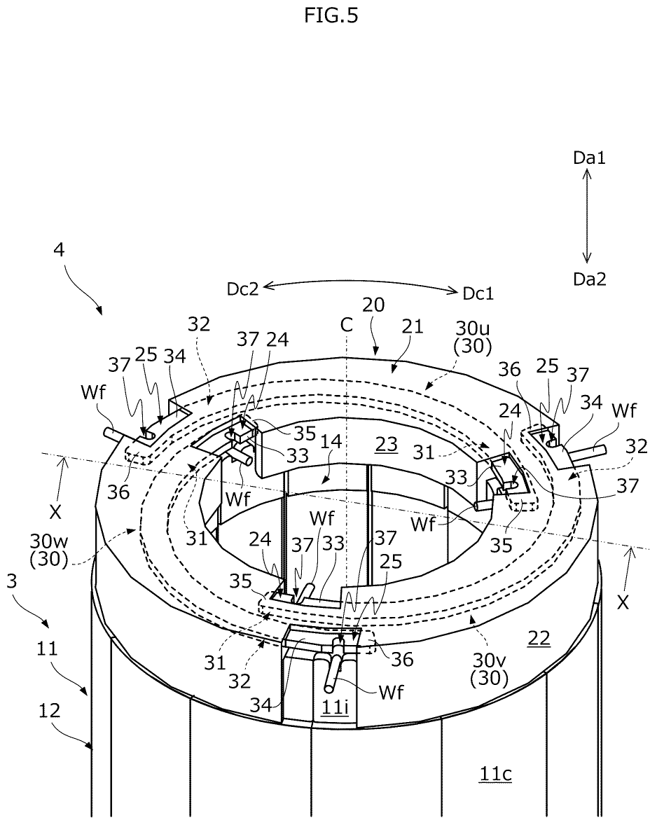

The first bus bar unit 4 is a component that is mounted on the first axial direction Da1 side of the stator 3 and connects the coils 16 of three phases on a phase by phase basis, and includes the resin holder 20 and the bus bars 30 as illustrated in FIG. 5. The bus bars 30 are conductive members that connect the coils 16 of the three phases on a phase by phase basis, and are covered with (buried in) the holder 20. In other words, the first bus bar unit 4 is provided as an insert-molded product in which the bus bars 30 are assembled with the resin holder 20 or molded with the resin holder 20.

In the embodiment, the end wires Wf of the two phase-U coil groups 17u, the end wires Wf of the two phase-V coil groups 17v, and the end wires Wf of the two phase-W coil groups 17w are drawn out in the first axial direction Da1. Therefore, as illustrated in FIGS. 3 and 5, the first bus bar unit 4 is provided with three bus bars 30 including a phase-U bus bar 30u that connects the end wires Wf of the two phase-U coil groups 17u, a phase-V bus bar 30v that connects the end wires Wf of the two phase-V coil groups 17v, and a phase-W bus bar 30w that connects the end wires Wf of the two phase-W coil groups 17w.

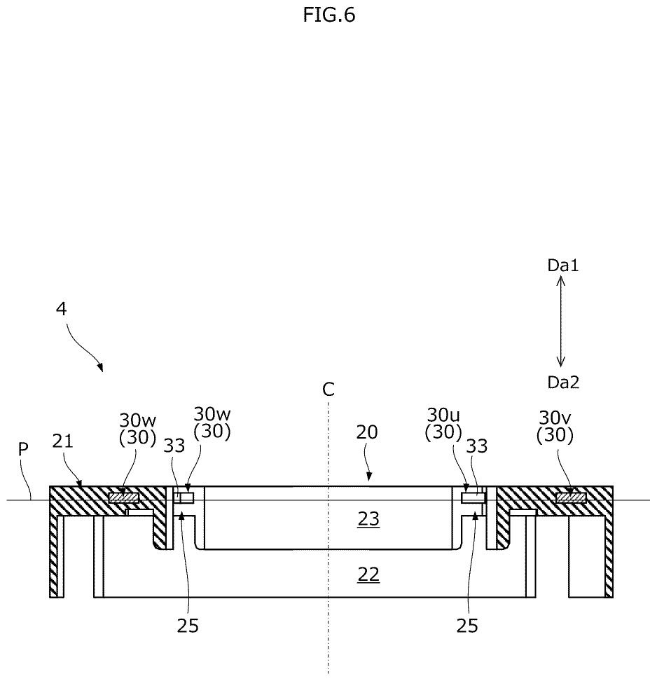

The holder 20 has a ring shape around the axis. In the embodiment, as illustrated in FIG. 5, the holder 20 is provided in such a manner that its axis agrees with the axis C of the motor 1 (the shaft 1s), and has a circular ring shape surrounding the axis C as viewed in the axial direction. As illustrated in FIGS. 5 and 6, the holder 20 may be provided with a main body portion 21 that is expanded in a direction orthogonal to the axis C, has a circular ring shape as viewed in the axial direction, and has a flat plate shape as viewed in the radial direction, as a portion that covers the three bus bars 30.

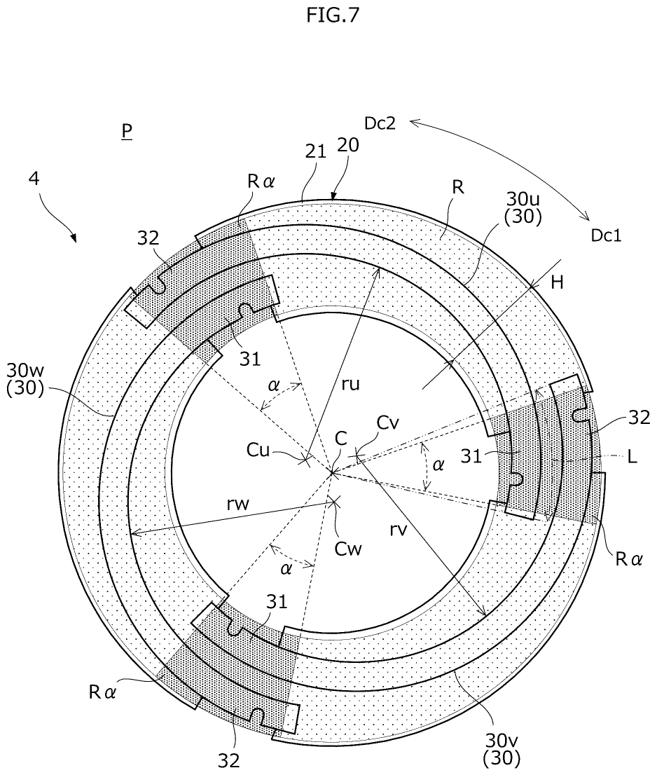

As illustrated in FIG. 6, the three bus bars 30 are placed on a plane P overlapping the main body portion 21 in the axial direction. As illustrated in FIG. 7, the three bus bars 30 are placed in a ring-shaped region R (sparsely and densely dotted regions illustrated in FIG. 7) having a predetermined radial width H substantially equal to a radial width of the main body portion 21 (the holder 20) on the plane P. Note that FIG. 7 is an axial cross-sectional view of the first bus bar unit 4 taken along the plane P as viewed in the first axial direction Da1, and in FIG. 7, hatching indicating cut surfaces of the holder 20 and the bus bars 30 is omitted for convenience. Put another way, the holder 20 includes the ring-shaped region R having the predetermined radial width H about the axis C on the plane P orthogonal to the axis C, and the bus bars 30 are placed in the ring-shaped region R.

Each of the three bus bars 30 has an arc shape as viewed in the axial direction. Each of the bus bars 30 may have, for example, a flat plate shape having a uniform thickness in the axial direction as viewed in the radial direction as illustrated in FIG. 6, and an extra-long plate shape having a circular arc shape as viewed in the axial direction as illustrated in FIG. 7. The bus bars 30 may have the same shape in which curvature radii ru, rv, and rw from centers Cu, Cv, and Cw of the arcs of the bus bars 30 are the same, the lengths of the circular arcs of the bus bars 30 relative to the centers Cu, Cv, and Cw of the arcs are the same, and the thicknesses of the bus bars 30 are the same, and may be provided in such a manner as to be threefold rotational symmetric about the axis C.

Hereinafter, the center of the arc of the phase-U bus bar 30u is referred to as the phase-U bus bar center Cu, the center of the phase-V bus bar 30v is referred to as the phase-V bus bar center Cv, and the center of the phase-W bus bar 30w is referred to as the phase-W bus bar center Cw. The phase-U bus bar center Cu, the phase-V bus bar center Cv, and the phase-W bus bar center Cw are provided, displaced from one another. In the embodiment, the bus bar centers Cu, Cv, and Cw are provided at the same distance from the axis C, but are equally spaced apart from one another around the axis C. In this manner, the bus bar centers Cu, Cv, and Cw are also displaced from the axis C; therefore, the bus bars 30u, 30v, and 30w are, to put is another way, off the axis C.

Each of the bus bars 30 is provided in such a manner that a part thereof overlaps (is adjacent in the radial direction to) another bus bar 30 in the radial direction in an area of a predetermined angle α (a predetermined angle area) about the axis C in the ring-shaped region R. Hereinafter, in the ring-shaped region R, a partial circular ring (approximately trapezoidal) region (the densely dotted region in FIG. 7) having the predetermined angle α in which a part of each of the bus bars 30 overlaps another bus bar 30 in the radial direction is referred to as a predetermined angle region Rα. The predetermined angle α defining the predetermined angle region Rα is simply required to be at least smaller than the central angle of the circular arc of each of the bus bars 30, and is not particularly limited, but is preferably set at an angle obtained by dividing 360° by the number of the slots 15 of the stator 3 (here, 30° obtained by dividing 360° by 12).

In the embodiment, portions on both sides of each of the bus bars 30 in the circumferential direction are the above part, and the portions on both sides of each of the bus bars 30 in the circumferential direction are provided in such a manner as to overlap the other bus bars 30, respectively, in the radial direction in the predetermined angle regions Rα. More specifically, a portion on the first circumferential direction Dc1 side of one (for example, the phase-U bus bar 30u) of the three bus bars 30 is provided in such a manner as to overlap a portion on the second circumferential direction Dc2 side of one (for example, the phase-V bus bar 30v) of the remaining two bus bars 30 in the radial direction in the predetermined angle region Rα. Moreover, a portion on the second circumferential direction Dc2 side of the one bus bar 30 (for example, the phase-U bus bar 30u) is provided in such a manner as to overlap a portion on the first circumferential direction Dc1 side of the other (for example, the phase-W bus bar 30w) of the remaining two bus bars 30 in the radial direction in the predetermined angle region Rα. Correspondingly, in the ring-shaped region R, three predetermined angle regions Rα are equally spaced apart from one another in the circumferential direction.

Hereinafter, the portion on the first circumferential direction Dc1 side of each of the bus bars 30 is referred to as a first portion 31, and the portion on the second circumferential direction Dc2 side is referred to as a second portion 32. The first portion 31 of each of the bus bars 30 (for example, the phase-U bus bar 30u) is located radially inward of the second portion 32 of another bus bar 30 (for example, the phase-V bus bar 30v) overlapping the first portion 31 in the radial direction in the predetermined angle region Rα. In other words, the three bus bars 30 are placed in the circumferential direction in such a manner as to overlap in the radial direction in the predetermined angle regions Rα with the first portions 31 and the second portions 32 staggered.

As described above, the bus bar centers Cu, Cv, and Cw of the three bus bars 30 are displaced from one another, which makes such placement possible. Moreover, this makes it possible to provide the first bus bar unit 4 with the three bus bars 30 on the same plane P without overlapping in the axial direction. Hence, the thickness in the axial direction of a portion (the main body portion 21), which covers the bus bars 30, of the holder 20 can be reduced; therefore, it is encouraged to prevent an increase in the size of the motor 1 in the axial direction.

Hereinafter, the configuration of the first bus bar unit 4 is described in detail in a different way from the above-mentioned description.

In the first bus bar unit 4, the three bus bars 30 are provided to the holder 20 at the same position in the axial direction, that is, on the same plane P, as illustrated in FIG. 6 without overlapping one another as viewed in the axial direction as illustrated in FIG. 5. Moreover, as illustrated in FIG. 5, each of the bus bars 30 is provided in such a manner as to extend along the circumferential direction and in such a manner that the first portion 31 on the first circumferential direction Dc1 side (one end side) is located radially inward of the second portion 32 on the second circumferential direction Dc2 side (the other end side). Note that the expression “extending along” referred to in the embodiment is not limited to extending in a direction that agrees with (is parallel to) a reference direction (for example, the circumferential direction), and includes extending in a direction inclined with respect to the reference direction.

The first portion 31 of each of the bus bars 30 (for example, the phase-U bus bar 30u) and the second portion 32 of any of the bus bars 30 (for example, the phase-V bus bar 30v) other than the bus bar 30 are provided in such a manner as to overlap as viewed in the radial direction. In other words, the first portion 31 of each of the bus bars 30 is provided in such a manner as to overlap the second portion 32 of another bus bar 30 that connects the coil group 17 of a phase different from the coil group 17 of a phase (hereinafter, also referred to as the “corresponding phase”) connected by the bus bar 30 as viewed in the radial direction. Note that the expression “overlapping as viewed in the radial direction” is synonymous with being located on the radius passing through the axis C. In other words, the placement of the bus bars 30 is set in such a manner that when a radius passing through the first portion 31 of one bus bar 30 is drawn from the axis line C, the second portion 32 of another bus bar 30 is located on the radius.

Consequently, as illustrated in FIG. 3, the first portion 31 and the second portion 32 of the bus bar 30 of each phase (for example, the phase-U bus bar 30u) can extend to near two coil groups 17 of the corresponding phase (for example, the phase-U coil groups 17u) respectively without the three bus bars 30 overlapping in the axial direction. Hence, the first bus bar unit 4 including the three bus bars 30 can be placed in a space narrower in the axial direction than a known bus bar unit in which a plurality of bus bars is stacked in the axial direction, and it is encouraged to prevent an increase in the size of the motor 1 in the axial direction. Moreover, distances between the bus bar 30 of each phase and the coil groups 17 of the corresponding phase can be reduced; therefore, the end wires Wf (the windings W) drawn out from the coil groups 17 of the corresponding phase can be joined to the bus bar 30 of each phase without being complicatedly routed.

For example, as illustrated in FIG. 3, the first portion 31 and the second portion 32 of the bus bar 30 of each phase may be provided in such a manner as to axially overlap the slots 15 from which the end wires Wf of the coil groups 17 of the corresponding phase are drawn out. In the embodiment, as described above, the end wires Wf of the windings W forming the coil groups 17 of different phases adjacent to each other in the circumferential direction are drawn out from the three slots 15 being every fourth slot located in the circumferential direction. Therefore, the first portion 31 of the bus bar 30 (for example, the phase-U bus bar 30u) to which one of the end wires Wf of the coil groups 17 of different phases adjacent to each other in the circumferential direction is joined and the second portion 32 of the bus bar 30 (for example, the phase-V bus bar 30v) to which the other of the end wires Wf is joined are provided in such a manner as to overlap the common slot 15 in the axial direction, and the first bus bar unit 4 is provided with three places where the first portion 31 and the second portion 32 are adjacent to each other in the radial direction.

Preferably, a length L (refer to FIG. 7) in which the first portion 31 of each of the bus bars 30 (for example, the phase-U bus bar 30u) and the second portion 32 of any of the bus bars 30 (for example, the phase-V bus bar 30v) other than the bus bar 30 overlap each other in the circumferential direction is substantially equal to a length of a fan-shaped circular arc having an angle obtained by dividing 360° by the number of the slots 15 of the stator 3 as a central angle. The 12 slots 15 are provided here; therefore, the overlap length L between the first portion 31 and the second portion 32 is substantially equal to the length of the circular arc of the fan having a central angle of 30° obtained by dividing 360° by 12.

In the embodiment, the first bus bar unit 4 is mounted on the stator 3 in such a manner that the above-mentioned three predetermined angle regions Rα overlap the three slots 15 being every fourth slot located in the circumferential direction, respectively; therefore, a placement relationship of the first portions 31 and the second portions 32 of the bus bars 30 relative to the above-mentioned slots 15 and a relationship of the overlap length L between the first portions 31 and the second portions 32 are achieved. In the first bus bar unit 4, as described above, the first portion 31 and the second portion 32 of each of the bus bars 30 are provided in such a manner as to overlap in the axial direction with the slots 15 from which the end wires Wf of the coil groups 17 of the corresponding phase are drawn out, respectively. As a result, the end wires Wf drawn out from the coil groups 17 of each phase can be wired to the bus bar 30 of the corresponding phase without being routed in the circumferential direction; therefore, complicated wiring of the end wires Wf is further prevented.

As illustrated in FIG. 3, of two in-phase coil groups 17 connected by each of the bus bars 30, the end wire Wf of the coil group 17 (one of the two coils) located on the first circumferential direction Dc1 side relative to the bus bar 30 is joined to the first portion 31 of the bus bar 30. Moreover, of the two in-phase coil groups 17 connected by each of the bus bars 30, the end wire Wf of the coil group 17 (the other of the two coils) located on the second circumferential direction Dc2 side relative to the bus bar 30 is joined to the second portion 32 of the bus bar 30.

Hereinafter, in the first portion 31 of each of the bus bars 30, a portion to which the winding W of the coil group 17 of the corresponding phase located on the first circumferential direction Dc1 side relative to the bus bar 30 is joined is referred to as a first joint portion 33. Moreover, in the second portion 32 of each of the bus bars 30, a portion to which the winding W of the coil group 17 of the corresponding phase located on the second circumferential direction Dc2 side relative to the bus bar 30 is joined is referred to as a second joint portion 34.

As illustrated in FIG. 5, the first joint portion 33 may be provided to the first portion 31 at a position excluding a first end portion 35 on the first circumferential direction Dc1 side. Similarly, the second joint portion 34 may be provided to the second portion 32 at a position excluding a second end portion 36 on the second circumferential direction Dc2 side. In terms of the radially inner side of the first joint portion 33 and the radially outer side of the second joint portion 34, grooves 37 for catching the end wires Wf that are joined to these joint portions 33 and 34 may be created by notching the radially inner side and the radially outer side.

Note that in the region (the predetermined angle region Rα) where the first portion 31 and the second portion 32 of two bus bars 30 overlap each other as viewed in the radial direction, the first joint portion 33 and the second joint portion 34 may be provided in such a manner that parts thereof in the circumferential direction overlap each other as viewed in the radial direction as illustrated in FIG. 5. In the region, the first portion 31 and the second portion 32 may not overlap each other throughout their length in the circumferential direction as viewed in the radial direction. Moreover, in the region, the position of the first joint portion 33 and the position of the second joint part 34 may agree (completely overlap) with each other in the circumferential direction.

As described above, the holder 20 is a resin member that covers the bus bars 30, and is mounted on the stator 3. In the embodiment, the holder 20 includes the circular ring-shaped main body portion 21, and outer wall portions 22 and inner wall portions 23, which stand in the second axial direction Da2 on the main body portion 21.

The main body portion 21 is a resin member that covers the bus bars 30, and has, for example, a circular ring shape (doughnut shape) as viewed in the axial direction and a flat plate shape as viewed in the radial direction as illustrated in FIG. 6. The main body portion 21 is preferably set to be slightly thicker in the axial direction than the bus bars 30 to the extent that the three bus bars 30 can be covered from both sides in the axial direction.

As illustrated in FIG. 5, the main body portion 21 may be provided with first notches 24 for exposing the first joint portions 33 and second notches 25 for exposing the second joint portions 34. In the embodiment, three first notches 24 and three second notches 25 are provided, corresponding to the configuration in which the three bus bars 30 each including the first joint portion 33 and the second joint portion 34 are provided.

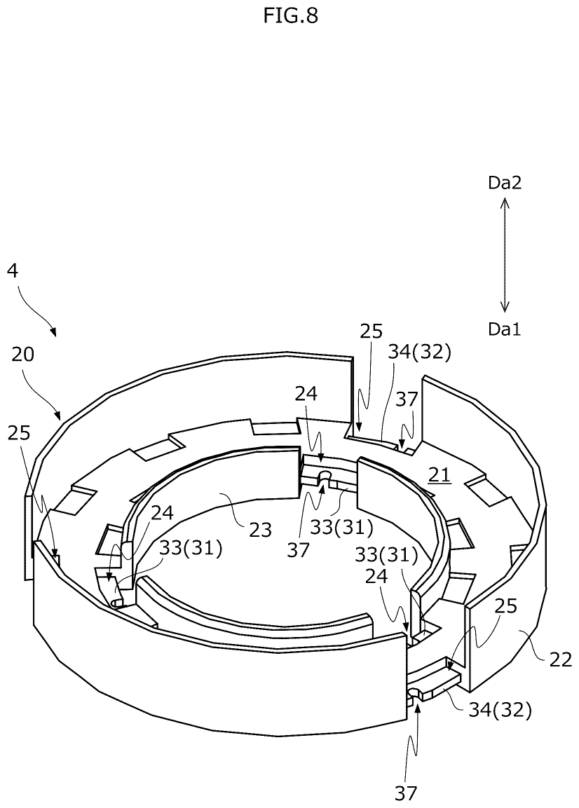

Each of the first notches 24 is a portion that is recessed into the main body portion 21 from the radially inner side and forms a space that exposes the first joint portion 33 in the first axial direction Da1. Preferably, each of the first notches 24 exposes only the first joint portion 33 of the first portion 31 in the first axial direction Da1. In other words, each of the first notches 24 is provided in such a manner as not to expose, from the main body portion 21, portions, which are adjacent to both sides of the first joint portion 33 in the circumferential direction, of the first portion 31. As illustrated in FIGS. 6 and 8, each of the first notches 24 may be provided in such a manner as to penetrate the main body portion 21 in the axial direction, or may be provided in such a manner as to retain a portion, which is on the second axial direction Da2 side relative to the first joint portion 33, of the main body portion 21. Note that the first joint portions 33 are also exposed radially inward by the first notches 24.

Each of the second notches 25 is a portion that is recessed into the main body portion 21 from the radially outer side and forms a space that exposes the second joint portion 34 in the first axial direction Da1. Preferably, each of the second notches 25 exposes only the second joint portion 34 of the second portion 32 in the first axial direction Da1, as in the first notches 24. In other words, each of the second notches 25 is provided in such a manner as not to expose, from the main body portion 21, portions, which are adjacent to both sides of the second joint portion 34 in the circumferential direction, of the second portion 32. As illustrated in FIGS. 5 and 8, each of the second notches 25 may be provided in such a manner as to penetrate the main body portion 21 in the axial direction, or may be provided in such a manner as to retain a portion, which is on the second axial direction Da2 side relative to the second joint portion 34, of the main body portion 21, as in the first notches 24. Note that the second joint portions 34 are also exposed radially outward by the second notches 25.

As illustrated in FIG. 8, a plurality of (here, three) indentations recessed into an end surface on the second axial direction Da2 side of the main body portion 21 may be provided between the three second notches 25 in the circumferential direction. Similarly, a plurality of (here, three) indentations recessed into an end surface on the second axial direction Da2 side of the main body portion 21 may be provided between the three first notches 24 in the circumferential direction. The first notches 24 and the second notches 25 and these indentations can be used to temporarily position the split cores 11n if the core unit 11 includes the split cores 11n.

Each of the outer wall portions 22 is a portion that stands in the second axial direction Da2 on an outer peripheral edge of the circular ring-shaped main body portion 21. The outer wall portions 22 may each have, for example, a circular arc shape standing on the main body portion 21 at positions excluding the second notches 25. For example, as illustrated in FIG. 5, the outer wall portions 22 surround the outer peripheral wall 12 of the core unit 11 from the radially outer side and come into contact with the step between the insulator 11i and the stator core 11c to allow the holder 20 to be mounted on the first axial direction Da1 side of the stator 3. In this manner, the holder 20 is directly mounted on the stator core 11c not via the insulator 11i to prevent variations in the positions of the bus bars 30 in the axial direction relative to the stator 3 due to the influence of a dimensional error of the insulator 11i.

As illustrated in FIG. 8, each of the inner wall portions 23 is a portion that stands in the second axial direction Da2 on an inner peripheral edge of the circular ring-shaped main body portion 21. The inner wall portions 23 may each have, for example, a circular arc shape standing on the main body portion 21 at positions excluding the first notches 24. As illustrated in FIG. 5, the inner wall portions 23 may be provided in such a manner as to surround the inner peripheral walls 14 of the core unit 11 from the radially inner side when the first bus bar unit 4 is assembled to the stator 3. The inner wall portions 23, together with the outer wall portions 22, can be used to temporarily position the split cores 11n if the core unit 11 includes the split cores 11n.

When the first bus bar unit 4 is assembled to the stator 3, the end wires Wf of two in-phase coil groups 17 are drawn (hooked) radially inward and outward, respectively, before the first bus bar unit 4 is mounted on the stator 3. More specifically, of the end wires Wf of the two in-phase coil groups 17, the end wire Wf that is joined to the first joint portion 33 is hooked radially inward, and the end wire Wf that is joined to the second joint portion 34 is hooked radially outward. Note that FIG. 5 illustrates a state in which the end wires Wf are drawn radially inward and outward.

The first bus bar unit 4 is thereafter mounted on the stator 3 in such a manner that the first joint portion 33 is adjacent to the end wire Wf hooked radially inward and the second joint portion 34 is adjacent to the end wire Wf hooked radially outward. In this manner, in the region (the predetermined angle region Rα) where the first portion 31 and the second portion 32 of two bus bars 30 overlap each other as viewed in the radial direction, the end wire Wf that is joined to the first joint portion 33 and the end wire Wf that is joined to the second joint portion 34 are hooked in the directions different from each other to allow the windings W to be wired without being entangled or crossed. Hence, it is encouraged to prevent contact between the end wires Wf and simplify the routing of the end wires Wf.

Moreover, the portion, which is drawn out in the first axial direction Da1, of each of the windings W forming its respective coil group 17 is the end wire Wf that is a free end as described above; therefore, the windings W can be easily hooked in this manner.

After the first bus bar unit 4 is mounted on the stator 3, the end wires Wf drawn radially inward are folded in the first axial direction Da1 and radially outward, are caught in the grooves 37 of the adjacent first joint portions 33, and come into contact with the first joint portions 33 from the first axial direction Da1 side. The first joint portions 33 are exposed in the first axial direction Da1 by the first notches 24; therefore, the end wires Wf can be wired in this manner. The end wires Wf are thereafter joined to the first joint portions 33 by spot welding in which the end wires Wf and the first joint portions 33 are pressurized from the first axial direction Da1 side and melt-bonded together.

After the first bus bar unit 4 is mounted on the stator 3, the end wires Wf drawn radially outward are folded in the first axial direction Da1 and radially inward, are caught in the grooves 37 of the adjacent second joint portions 34, and come into contact with the second joint portions 34 from the first axial direction Da1 side. As in the first joint portions 33, the second joint portions 34 are exposed in the first axial direction Da1 by the second notches 25; therefore, the end wires Wf can be wired in this manner. The end wires Wf are thereafter joined to the second joint portions 34 by spot welding in which the end wires Wf and the second joint portions 34 are pressurized from the first axial direction Da1 side and melt-bonded together.

In this manner, the end wires Wf are joined to the joint portions 33 and 34 respectively not by manual soldering but by spot welding, thereby encouraging a reduction in the number of man-hours related to the connection process of the end wires Wf. The joint portions 33 and 34 that are pressurized in the second axial direction Da2 at the time of spot welding are supported by the bus bars 30 (the portions excluding the joint portions 33 and 34) covered with the main body portion 21 of the holder 20 that is mounted on the stator 3. Hence, the joint portions 33 and 34 are prevented from moving in the second axial direction Da2, or the bus bars 30 are prevented from falling out, during spot welding. In particular, if the joint portions 33 and 34 are provided to the portions excluding the first end portions 35 and the second end portions 36 as described above, the portions adjacent to both sides of each of the joint portions 33 and 34 are covered with the main body portion 21 to enter into a state where the joint portions 33 and 34 are supported at both ends thereof. Hence, forces that hold the bus bars 30 at the time of spot welding increase, which further prevents the bus bars 30 from falling out.

### 1-5. Second Bus Bar Unit

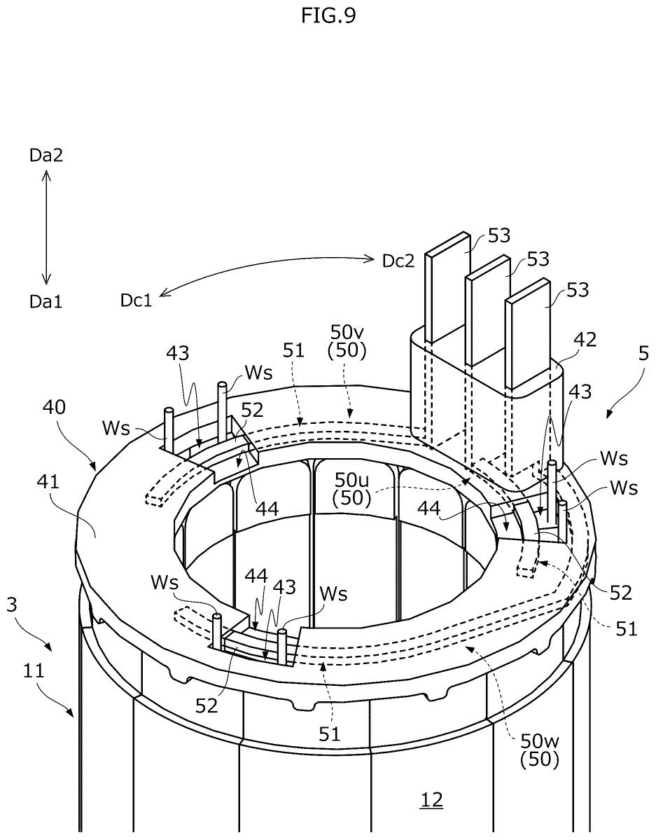

The second bus bar unit 5 is a component that is mounted on the second axial direction Da2 side of the stator 3 and connects the coils 16 of the three phases in a delta connection (delta connection), and includes a resin holder 40 and the bus bars 50 as illustrated in FIG. 9. The second bus bar unit 5 is provided as an insert-molded product in which the bus bars 50 are assembled with the resin holder 40 or molded with the resin holder 40.

Each of the bus bars 50 is a conductive member that connects the coils 16 of two different phases among the coils 16 of the three phases. In the embodiment, the start wires Ws of the two phase-U coil groups 17u, the start wires Ws of the two phase-V coil groups 17v, and the start wires Ws of the two phase-W coil groups 17w are drawn out toward the second axial direction Da2 side of the stator 3. Correspondingly, the second bus bar unit 5 is provided with three bus bars 50 including a U-line bus bar 50u, a V-line bus bar 50v, and a W-line bus bar 50w.

As illustrated in FIG. 3, the U-line bus bar 50u connects the start wire Ws of one of the two phase-U coil groups 17u and the start wire Ws of one of the two phase-V coil groups 17v. The V-line bus bar 50v connects the start wire Ws of the other of the two phase-V coil groups 17v and the start wire Ws of one of the two phase-W coil groups 17w. The W-line bus bar 50w connects the start wire Ws of the other of the two phase-U coil groups 17u and the start wire Ws of the other of the two phase-W coil groups 17w.

As illustrated in FIG. 9, each of the three bus bars 50 may include a base plate portion 51 that extends along the circumferential direction and is covered with (buried in) the holder 40. Each of the base plate portions 51 has, for example, an extra-long plate shape extending along the circumferential direction. The three base plate portions 51 may be provided at the same position in the axial direction, and may be provided in such a manner as not to overlap one another as viewed in the axial direction, that is, provided on the same plane.

The start wire Ws of each of the coil groups 17 is joined to a part of the base plate portion 51. Hereinafter, a portion, to which the start wire Ws is joined, of the base plate portion 51 of each of the bus bars 50 is referred to as a joint portion 52. As illustrated in FIG. 3, each of the U-line bus bar 50u, the V-line bus bar 50v, and the W-line bus bar 50w may connect the start wires Ws of the coil groups 17 of different phases, the start wires Ws being drawn out from the common slot 15. Correspondingly, each of the bus bars 50 may be provided with one joint portion 52, and the joint portion 52 of each of the bus bars 50 may be provided in such a manner as to overlap in the axial direction with the slot 15 from which the start wires Ws connected by the bus bar 50 are drawn out.

As illustrated in FIG. 9, three joint portions 52 may be equally spaced apart from one another in the circumferential direction in such a manner as to overlap with the three slots 15 respectively, corresponding to the configuration in which the start wires Ws of the coil groups 17 are drawn out from the three slots 15 being every fourth slot located in the circumferential direction. Note that FIG. 9 illustrates a state in which the start wires Ws are drawn out in the second axial direction Da2. For example, the three joint portions 52 may be placed in such a manner as to be located radially inward of the start wires Ws with the second bus bar unit 5 mounted on the stator 3.

Note that each of the bus bars 50 may be provided as a terminal that is electrically connected to an unillustrated external power feeding device. In this case, each of the bus bars 50 may further include a terminal portion 53 that stands in the second axial direction Da2 on an end portion in the extension direction of the base plate portion 51 and is connected to the external power feeding device.

As described above, the holder 40 is a resin member that covers the base plate portions 51 of the bus bars 50, and is mounted on the stator 3. The holder 40 may be provided with a main body portion 41 for covering the base plate portions 51 of the bus bars 50. If each of the bus bars 50 is provided as a terminal, the holder 40 may be provided with a protruding portion 42 for covering portions of the terminal portions 53 of the bus bars 50 on the first axial direction Da1 side.

The main body portion 41 has, for example, a circular ring shape (doughnut shape) as viewed in the axial direction and a flat plate shape as viewed in the radial direction. The main body portion 41 may be provided, around the joint portions 52, with through-holes 43 and notches 44, as a part of the configuration that encourages a reduction in the number of man-hours related to the assembly of the second bus bar unit 5 to the stator 3 and the connection process of the start wires Ws. Three through-holes 43 and three notches 44 may be provided, corresponding to the configuration in which the three joint portions 52 are provided.

Each of the through-holes 43 is a hole that penetrates in the axial direction and through which the start wires Ws are inserted. Moreover, each of the notches 44 is a portion that forms a space on the radially inner or outer side of the through-hole 43 by notching the main body portion 41 from the second axial direction Da2 side in such a manner as to expose the joint portion 52 of the base plate portion 51 in the second axial direction Da2. Each of the notches 44 may be provided adjacent to the radially inner side of the through-hole 43, corresponding to the placement in which the joint portion 52 is located radially inward of the start wire Ws.

For example, the start wires Ws of the coil groups 17 of different phases connected by each of the bus bars 50 are drawn out from the common slot 15 and inserted through the common through-hole 43 as illustrated in FIG. 9. A portion, which is drawn out in the second axial direction Da2, of each of the windings W forming its respective coil group 17 is the start wire Ws that is the fixed end. As described above, the start wires Ws have the characteristic that the positions of the start wires Ws are less likely to vary among the coil groups 17; therefore, the start wires Ws can be inserted through the through-holes 43 simply by mounting the second bus bar unit 5 on the stator 3. This eliminates the need for a process of adjusting the positions of the start wires Ws and a process of locking the start wires Ws somewhere, which encourages a reduction in the number of man-hours related to the assembly of the second bus bar unit 5 to the stator 3. Moreover, the start wires Ws can be drawn out at positions suitable for joining to the joint portions 52, that is, at positions passing through the through-holes 43, with high reproducibility.

The start wires Ws inserted through the through-holes 43 are folded radially inward and come into contact with the joint portions 52 exposed in the second axial direction Da2 by the notches 44, from the second axial direction Da2 side. The start wires Ws in contact with the joint portions 52 are joined to the joint portions 52 not by manual soldering but by spot welding in which the joint portions 52 and the start wires Ws are pressurized from the second axial direction Da2 side and melt-bonded together. Hence, it is encouraged to reduce the number of man-hours related to the connection process of the start wires Ws.

The joint portions 52 that are pressurized in the first axial direction Da1 at the time of spot welding are supported by the base plate portions 51 covered with the main body portion 41 of the holder 40 that is mounted on the stator 3. Hence, the joint portions 52 are prevented from moving in the first axial direction Da1, or the bus bars 50 are prevented from falling out, during spot welding. To put another way, in the embodiment, the base plate portions 51 are covered with the holder 40 that is mounted on the stator 3, and the notches 44 are provided which expose the joint portions 52 of the base plate portions 51 in the second axial direction Da2. Therefore, the joint portions 52 and the start wires Ws can be joined not by manual soldering but by spot welding.

Moreover, the portion, which is joined to the joint portion 52, of the winding W of each of the coil groups 17 is the start wire Ws in which variations are less likely to occur at the drawing position, and these start wires Ws are always drawn out from the through-holes 43. Therefore, the reproducibility of the positions of the start wires Ws to be spot-welded is improved. Hence, when the joining process of the start wires Ws is automated and incorporated into a manufacturing process of the motor 1, it is possible to prevent a handling operation of the start wires Ws from becoming complicated.

### 2. Operations and Effects

(1) In the above-mentioned first bus bar unit 4, the holder 20 includes the ring-shaped region R having the predetermined radial width H about the axis C on the plane P orthogonal to the axis C, and the bus bars 30 are placed in the ring-shaped region R. Moreover, the centers of the arcs of the bus bars 30 are displaced from one another, and at least a part of each of the bus bars 30 overlaps another bus bar 30 in the predetermined angle area in the ring-shaped region R. Consequently, it is possible to reduce the axial thickness of the portion (the main body portion 21 in the embodiment), which covers the bus bars 30, of the holder 20. Hence, in the axial direction, it is possible to encourage space saving inside the motor 1; therefore, it is possible to prevent an increase in the size of the motor.
(2) In the above-mentioned first bus bar unit 4 and motor 1, the holder 20 covers the three bus bars 30 that connect the coils 16 (the coil groups 17) of the three phases provided in the stator 3 on a phase by phase basis, at the same position in the axial direction relative to the holder 20. Consequently, it is possible to reduce the axial thickness of the portion (the main body portion 21 in the embodiment), which covers the bus bars 30, of the holder 20. Hence, in the axial direction, it is possible to encourage space saving inside the motor 1; therefore, it is possible to prevent an increase in the size of the motor.

Moreover, in the above-mentioned first bus bar unit 4 and motor 1, the first portion 31 of the bus bar 30 of each phase is provided in such a manner as to be located radially inward of the second portion 32 of the bus bar 30 and overlap the second portion 32 of the bus bar 30 of a different phase from the bus bar 30 as viewed in the radial direction. Consequently, the first portion 31 and the second portion 32 of the bus bar 30 of each phase can be extended to near the coils 16 (the coil groups 17) of the corresponding phase. Therefore, the end wires Wf (the windings W) and the bus bar 30 of each phase can be joined without requiring complicated routing of the end wires Wf.
(3) In the above-mentioned first bus bar unit 4, the first joint portions 33 of the bus bars 30 covered with the holder 20 that is mounted on the stator 3 are exposed by the first notches 24 in the first axial direction Da1. Moreover, similarly, the second joint portions 34 of the bus bars 30 covered with the holder 20 that is mounted on the stator 3 are exposed by the second notches 25 in the first axial direction Da1. Consequently, before the first bus bar unit 4 is mounted on the stator 3, the end wires Wf hooked radially inward and outward can be joined by spot welding to the first joint portions 33 and the second joint portions 34 from the first axial direction Da1 side. Therefore, it is possible to reduce the number of man-hours for assembly as compared to manual solder bonding.
(4) Furthermore, in the above-mentioned first bus bar unit 4, only the first joint portions 33 of the first portions 31 are exposed by the first notches 24 in the first axial direction Da1, and the portions adjacent to both sides of each of the first joint portions 33 are covered with the holder 20 without being exposed. Moreover, only the second joint portions 34 of the second portions 32 are exposed by the second notches 25 in the first axial direction Da1, and the portions adjacent to both sides of each of the second joint portions 34 are covered with the holder 20 without being exposed. Consequently, the joint portions 33 and 34 are in a state where both ends thereof are supported; therefore, it is possible to join the end wires Wf to the joint portions 33 and 34 more appropriately.
(5) If the grooves 37 for catching the end wires Wf are provided on the radially inner sides of the first joint portions 33 and the radially outer sides of the second joint portions 34 respectively, it is possible to determine the positions of the end wires Wf relative to the joint portions 33 and 34 before the end wires Wf are joined to the joint portions 33 and 34. Hence, it is possible to join the end wires Wf to the joint portions 33 and 34 more appropriately.
(6) If the portion, which is drawn out in the first axial direction Da1, of each of the windings W forming its respective coil group 17 is the end wire Wf that is a free end, it is possible to easily hook the end wires Wf that are joined to the first joint portions 33 to the radially inner sides and the end wire Wf that are joined to the second joint portions 34 to the radially outer sides. Moreover, if in the region where the first portion 31 and the second portion 32 of two bus bars 30 overlap each other as viewed in the radial direction, the end wire Wf that is joined to the first joint portion 33 and the end wire Wf that is joined to the second joint portion 34 are hooked in the directions different from each other in the radial direction to allow the end wires Wf to be wired without being entangled or crossed. Hence, it is possible to encourage simplification of the routing of the end wires Wf and to prevent the end wires Wf from coming into contact with each other and passing current therebetween.
(7) If the length L of the overlap in the circumferential direction between the first portion 31 of each of the bus bars 30 and the second portion 32 of another bus bar 30 is substantially equal to the length of the fan-shaped circular arc having the angle obtained by dividing 360° by the number of the slots 15 of the stator 3 as the central angle, it further facilitates encouraging insulation between the bus bars 30 and it is possible to prevent wiring of the end wires Wf from becoming complicated, as compared to a case where the overlap length L between the first portion 31 and the second portion 32 is greater than the circular arc length.
(8) If all of the three bus bars 30 provided to the first bus bar unit 4 have the same shape, commonality of the component (the bus bar 30) can be enhanced. Hence, it is possible to contribute to a reduction in the manufacturing cost of the motor 1.

### 3. Others

The above-mentioned configurations of the first bus bar unit 4 and the motor 1 are examples, and their configurations are not limited to the above-mentioned ones. For example, in the motor 1, the second bus bar unit 5, the stator 3, and the first bus bar unit 4 may be placed in this order in the second axial direction Da2 from the first axial direction Da1 side. In this case, the “predetermined axial direction” described in the claims is the second axial direction Da2. The first circumferential direction Dc1 and the second circumferential direction Dc2 in the above-mentioned first bus bar unit 4 are mere examples, and these directions may be specified the other way around.

The first bus bar unit 4 may not be an insert-molded product in which the bus bars 30 are molded with the resin holder 20, but may be a structure in which the bus bars 30 are assembled (assembled) to the inside of the holder 20 after the resin holder 20 is molded. Similarly, the second bus bar unit 5 may not be an insert-molded product, but may be a structure in which the bus bars 50 are assembled (assembled) to the inside of the holder 40 after the resin holder 40 is molded. The end wires Wf may be joined by soldering to the first joint portions 33 and the second joint portions 34 of the bus bars 30 of the first bus bar unit 4. Similarly, the end wires Wf may be joined by soldering to the joint portions 52 of the bus bars 50 of the second bus bar unit 5.

The bus bar unit provided on the second axial direction Da2 side of the stator 3 may not be the second bus bar unit 5 that connects the coils 16 of the three phases in a delta connection (delta connection), and may be a bus bar unit that connects the coils 16 of the three phases in a star connection. Note that the motor 1 may not include the second bus bar unit 5.

The winding W does not need to form two in-phase coils 16 placed adjacent to each other, and may form, for example, a single coil 16. In other words, the number of the windings W provided to the stator 3 is not limited to six as described above. The number of the coils 16 provided to the stator 3 may not be 12, and may be at least a multiple of six.

The portion, which is drawn out in the first axial direction Da1, of each of the windings W forming its respective coil 16 (coil group 17) may not be the end wire Wf. In other words, the bus bars 30 of the first bus bar unit 4 may not connect the end wires Wf of the coils 16 (coil groups 17). Note that the end wires Wf of the windings W forming the coils 16 of different phases adjacent to each other in the circumferential direction may not be drawn out from the same slot 15.

The first notches 24 and the second notches 25, which are provided to the holder 20 of the first bus bar unit 4, may be omitted. For example, if the first end portion 35 of each of the bus bars 30 is provided in such a manner as to be located (protrude) radially inward of the holder 20 and functions as the first joint portion 33, the first notches 24 can be omitted. Similarly, if the second end portion 36 of each of the bus bars 30 is provided in such a manner as to be located (protrude) radially outward of the holder 20 and functions as the second joint portion 34, the second notches 25 can be omitted.

Moreover, in the above-mentioned embodiment, the portions adjacent to both sides of each of the first joint portions 33 and the second joint portions 34 are covered with the holder 20 of the first bus bar unit 4 without being exposed. However, these adjacent portions may be partly exposed from the holder 20. The grooves 37 provided to the joint portions 33 and 34 may be omitted. The outer wall portions 22 and the inner wall portions 23 of the holder 20 of the first bus bar unit 4 may be omitted. In this case, the main body portion 21 of the holder 20 may be directly mounted on the first axial direction Da1 side of the stator 3.

The holder 20 as the “holder” according to claim 1 of the claims is simply required to have at least a ring shape that surrounds the axis of the holder 20, the shape being capable of covering the bus bars 30, and may not have a circular ring shape. The holder 20 may have, for example, a non-circular shape such as a polygonal shape or an elliptical shape, and the main body portion 21 of the holder 20 may not have a plate shape as viewed in the radial direction. The bus bars 30 as the “bus bars” according to claim 1 of the claims are simply required to have at least an arc shape of which the center is displaced from one another, and may not have a circular arc shape. For example, if the holder 20 has an elliptical shape, the bus bars 30 may have an elliptical arc shape placed in an elliptical ring-shaped region.

The holder 20 as the “holder” according to claim 3 of the claims is simply required to have at least a shape that can cover the bus bars 30, and may not have a circular ring shape. The holder 20 may have, for example, a disc shape, a fan shape, or a rectangular shape, and the main body portion 21 of the holder 20 may not have a plate shape as viewed in the radial direction. The bus bars 30 as the “bus bars” according to claim 3 of the claims are simply required to at least extend along the circumferential direction, and the first portion 31 of each of the bus bars 30 is simply required to be located radially inward of the second portion, and may not have a circular arc shape that is off the axis C. The bus bars 30 may have a spiral shape that extends in such a manner as to gradually wind further outward in the radial direction from the first circumferential direction Dc1 side toward the second circumferential direction Dc2 side.

The number of the bus bars provided to the bus bar unit is not limited to three. Moreover, not all the bus bars provided to the bus bar unit may have the same shape.

### DESCRIPTION OF REFERENCE SIGNS

1 Motor (brushless motor)
1s Shaft
2 Rotor
3 Stator
4 First bus bar unit (bus bar unit)
15 Slot
16 Coil
16u Phase-U coil (coil)
16v Phase-V coil (coil)
16w Phase-W coil (coil)
17 Coil group (coils)
17u Phase-U coil group (coils)
17v Phase-V coil group (coil)
17w Phase-W coil group (coil)
20 Holder
24 First notch
25 Second notch
30 Bus bar
30u Phase-U bus bar (bus bar)
30v Phase-V bus bar (bus bar)
30w Phase-W bus bar (bus bar)
31 First portion
32 Second portion
33 First joint portion
34 Second joint portion
37 Groove
α Predetermined angle
C Axis
Cu Phase-U bus bar center (center of the arc)
Cv Phase-V bus bar center (center of the arc)
Cw Phase-W bus bar center (center of the arc)
Da1 First axial direction (predetermined axial direction)
H Predetermined radial width
L Overlap length (length of an overlap in the circumferential direction between the first portion of a bus bar and the second portion of any bus bar other than the bus bar)
P Plane
R Ring-shaped region
W Winding
Wf End wire

1. A bus bar unit comprising:
a plurality of arc-shaped bus bars; and
a holder having a ring shape around an axis, the holder being configured to cover the plurality of bus bars, wherein
the holder includes a ring-shaped region having a predetermined radial width about the axis on a plane orthogonal to the axis,
the bus bars are placed in the ring-shaped region, and centers of the arcs are displaced from one another, and
at least a part of each of the bus bars overlaps with another bus bar in a predetermined angle area in the ring-shaped region.

2. The bus bar unit according to claim 1, wherein all the bus bars have a same shape.

3. A bus bar unit of an inner rotor brushless motor including a ring-shaped stator and a rotor located on a radially inner side of the stator, the bus bar unit comprising:
a resin holder configured to be mounted on a predetermined axial direction side of the stator in an axial direction of the stator; and
a plurality of conductive bus bars configured to connect coils of three phases provided to the stator on a phase by phase basis, wherein
each of the bus bars extends along a circumferential direction of the stator and is covered with the holder at a same position in the axial direction relative to the holder, and a first portion on one end side in the circumferential direction is located on the inner side relative to a second portion on the other end side in the circumferential direction,
each of the bus bars includes:
a first joint portion provided to the first portion, to which a winding forming one of two coils connected by the bus bar is joined; and
a second joint portion provided to the second portion, to which a winding forming the other of the two coils is joined,
the first portion of each of the bus bars and the second portion of any of the bus bars other than the bus bar overlap each other as viewed in the radial direction, and
the holder includes: a first notch recessed from the inner side to expose the first joint portion in the predetermined axial direction; and a second notch recessed from a radially outer side to expose the second joint portion in the predetermined axial direction.

4. (canceled)

5. The bus bar unit according to claim 3, wherein end wires of the windings of the two coils are joined to the first joint portion and the second joint portion, respectively.

6. The bus bar unit according to claim 3, wherein portions, which are adjacent to both sides of the first joint portion in the circumferential direction, of the first portion and portions, which are adjacent to both sides of the second joint portion in the circumferential direction, of the second portion are covered with the holder.

7. The bus bar unit according to claim 3, wherein grooves in which the windings are caught are provided on the inner side of the first joint portion and on the outer side of the second joint portion.

8. The bus bar unit according to claim 3, wherein a length of overlap in the circumferential direction between the first portion of each of the bus bars and the second portion of any of the bus bars other than the bus bar is substantially equal to a length of a fan-shaped circular arc having an angle obtained by dividing 360° by the number of slots of the stator as a central angle.

9. The bus bar unit according to claim 3, wherein all the bus bars have a same shape.

10. A brushless motor comprising:
the bus bar unit according to claim 3;
the stator on which the bus bar unit is mounted; and
the rotor configured to rotate integrally with a shaft on the inner side of the stator.

11. A brushless motor comprising:
the bus bar unit according to claim 1;
a ring-shaped stator on which the bus bar unit is mounted; and
a rotor located on a radially inner side of the stator and configured to rotate integrally with a shaft on the inner side of the stator.
